(19) United States
(12) Patent Application Publication
(10) Pub. No.: US 2021/0312336 A1
(43) Pub. Date: Oct. 7, 2021

(54) FEDERATED LEARNING OF MACHINE LEARNING MODEL FEATURES

(71) Applicant: INTERNATIONAL BUSINESS MACHINES CORPORATION, Armonk, NY (US)

(72) Inventors: Mathieu SINN, Dublin (IE); Ngoc Minh TRAN, Dublin 15 (IE); Stefano BRAGHIN, Dublin (IE); Mark PURCELL, Naas (IE)

(73) Assignee: INTERNATIONAL BUSINESS MACHINES CORPORATION, Armonk, NY (US)

(21) Appl. No.: 16/839,896

(22) Filed: Apr. 3, 2020

(51) Int. Cl. G06N 20/20; G06F 21/60; G06N 5/04

(52) U.S. Cl. CPC G06N 20/20; G06N 5/043; G06F 21/602

(57) ABSTRACT

Embodiments for providing optimized machine learning model features using federated learning on distributed data in a computing environment by a processor. Machine learning model features may be learned from one or more data sets extracted from one or more localized machine learning models associated with one or more nodes. The machine learning model features may be aggregated using a centralized machine learning model at a source node. The one or more localized machine learning models may be trained using aggregated machine learning model features provided by the centralized machine learning model.

### GOVERNMENT LICENSE RIGHTS TO CONTRACTOR-OWNED INVENTIONS MADE UNDER FEDERALLY SPONSORED RESEARCH AND DEVELOPMENT

This invention was made with Government support under 824988 awarded by European Research Project. The Government has certain rights to this invention.

### BACKGROUND OF THE INVENTION

### Field of the Invention

The present invention relates in general to computing systems, and more particularly to, various embodiments for federated learning of machine learning model features in a computing environment using one or more computing processors.

### Description of the Related Art

In today's society, consumers, business persons, educators, and others use various computing network systems with increasing frequency in a variety of settings. Computer systems may be found in the workplace, at home, or at school. Computer systems may include data storage systems, or disk storage systems, to process and store data. In recent years, both software and hardware technologies have experienced amazing advancement. With the new technology, more and more functions are added, and greater convenience is provided for use with these computing systems. For example, a wide variety of computer systems have been used in machine learning. Machine learning is a field of artificial intelligence that uses statistical techniques to allow computers to learn from data without being explicitly programmed.

### SUMMARY OF THE INVENTION

Various embodiments for federated learning of machine learning model features in a computing environment by a processor, are provided. In one embodiment, by way of example only, a method for federated learning of machine learning model features (e.g., providing optimized machine learning model features using federated learning on distributed data) in a computing environment, again by a processor, is provided. Machine learning model features may be learned from one or more data sets extracted from one or more localized machine learning models associated with one or more nodes. The machine learning model features may be aggregated using a centralized machine learning model at a source node. The one or more localized machine learning models may be trained using aggregated machine learning model features provided by the centralized machine learning model.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting various user hardware and cloud computing components functioning in accordance with aspects of the present invention;

FIGS. 5A-5C is a block flow diagram depicting operations for federated learning of machine learning model features according to an embodiment of the present invention; and

FIG. 6 is a flowchart diagram depicting an exemplary method for providing optimized machine learning model features using federated learning on distributed data in a computing environment by a processor, again in which aspects of the present invention may be realized.

### DETAILED DESCRIPTION OF THE DRAWINGS

Over the last decade, data analytics has become an important trend in many industries including e-commerce, healthcare, manufacture and more. The reasons behind the increasing interest are the availability of data, variety of open-source machine learning tools and powerful computing resources. Nevertheless, machine learning tools for analyzing data are still difficult to use and automate, since a typical data analytics project contains many tasks that have not been fully automated yet. For example, predictive data analytics project have attempted to provide automation tools yet there still remains a need to fully automate the various steps. Feature engineering, the cornerstone of successful predictive modeling, is one of the most important and time consuming tasks in predictive analytic operations because it prepares inputs to machine learning models, thus deciding how machine learning models will perform. That is, feature engineering is a critical step in data science, which impacts the final prediction results. Feature engineering involves understanding domain knowledge and data exploration to discover relevant hand-crafted features from raw data.

“Features,” for example, are the observations or characteristics on which a model is built. The process of deriving a new abstract feature based on the given data is broadly referred to as feature engineering. It is typically done using one of the many mathematical or statistical functions called “transformations.” A key step in data science projects is the transformation of raw data into “features” that can be used as inputs for machine learning models. Often, the raw data is stored across various tables in a relational database and need to be combined in various ways. That is, “feature engineering” builds “features” out of existing data, which is often times spread out across multiple related tables. The relevant information needs to be extracted from the data and placed into a single table, which can then be used to train a machine learning model. What makes the task of effective feature engineering hard is that there are literally a countless number of options of transformations a data scientist could perform. Moreover, working through those options with the trial and error of applying transformations and assessing their impact is very time consuming, often infeasible to perform thoroughly. On the other hand, feature engineering is central to producing accurate models, which presents a dilemma to a data scientist on how much time to devote to it.

Within an entity (e.g., organization, corporation, academic institution, government agency, etc.), data is often distributed across different departments, lines of organizations, business, and/or geographies. Often, the data is unable to cross boundaries based on policy, regulations, or legal obligations or internal governance, risk and compliance (“GRC”) controls. When using machine learning (e.g., artificial intelligence “AI”) to make organizational or business processes more efficient and/or create new services/initiatives, these boundaries or “limitations” impose various restrictions both to the type and quality of machine learning (ML) models and feature learning that can be developed and trained such as, for example, an organization may only be able to use aggregated information as inputs to ML models, where aggregations are often defined manually in an ad-hoc fashion. Thus, a need exits for providing federated learning of machine learning model features in distributed datasets having various boundaries and limitations preventing aggregated information as inputs into machine learning models.

Accordingly, various embodiments are provided herein for providing federated learning of machine learning model features (e.g., providing optimized machine learning model features using federated learning on distributed data) in a computing environment. In one aspect, machine learning model features may be learned from one or more data sets extracted from one or more localized machine learning models associated with one or more nodes. The machine learning model features may be aggregated using a centralized machine learning model at a source node. The one or more localized machine learning models may be trained using aggregated machine learning model features provided by the centralized machine learning model.

In one aspect, the present invention provides for federated learning of machine learning model features on distributed data sets. In one aspect, input data may be received or collected. The input data may include, for example, data labels (e.g., distributed and/or centralized), raw data (distributed), local machine learning models for feature extractions, a central machine learning model for combining the feature, hyperparameters configuring the federated machine learning. Hyperparameters (e.g., the number of iterations in the gradient-based optimization) may be a step size of gradient updates (“learning rate”), a size of data batches on which to compute the gradients, and/or a strength of model regularizers as part of the training objective.

Using the input data, a machine learning operation may learn the local model features and the central machine learning model by transmitting gradients and current predictions from a source (e.g., an aggregator component) to one or more participants (e.g., local nodes), and current features from the participants to the source (e.g., the aggregator component).

The machine learning operation may then produce (as output) one or more trained local machine learning models (e.g., located on the participants) for feature extractions and a trained central machine learning model for combining/aggregating those features (e.g., the extracted features from the local machine learning models. The local model features may be of the same or of different dimensionality. The central machine learning model may perform a simple aggregation of the local features and/or deploy a more complex aggregation operation using a multi-layer machine learning model. Also, encrypted transmitted information may be used to perform the training of the central machine learning model in an encrypted domain. An entity resolution operation may be performed to link training data records across the participants (e.g., across the local nodes in distributed computing system such as, for example, in a cloud-based computing environment). Pretrained machine learnings models may be used locally and/or centrally.

Thus, the present invention provides for mitigating the problem of optimizing machine learning model features on distributed data by leveraging federated machine learning (“FMIL”). For example, consider distributed data (e.g., where “x” is distributed data and x=(x1, x2, . . . , xn, y)) residing in different departments and geographies of an entity (e.g., a multi-national bank “B”). Assume, the data “x1” are all the transactions of Customer A in Geography X. Assume, data “x2” are all the transactions of Customer A in Geography Y. Assume, xn is the credit history of Customer A in Geography Z and y is a binary (e.g., True/False) variable indicating whether Customer A was involved in prohibited activities.

Thus, the present invention enables building a machine learning model, which predicts y as a function of x1, x2, . . . , xn. The multi-national bank “B” may have historical data (x1, x2, . . . , xn, y) from numerous different customers, but for legal and GRC reasons the raw data cannot be centralized for machine learning model training purposes. Rather, multi-national bank “B” employs the various aspects of the present invention and uses aggregated features f1(x1), f2(x2), . . . , fn(xn) of the raw data, centralizes those features f1(x1), f2(x2), . . . , fn(xn), and trains a ML model on the aggregated features f1(x1), f2(x2), . . . , fn(xn). The aggregated features may be the result of a structured language query (“SQL”) aggregations.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

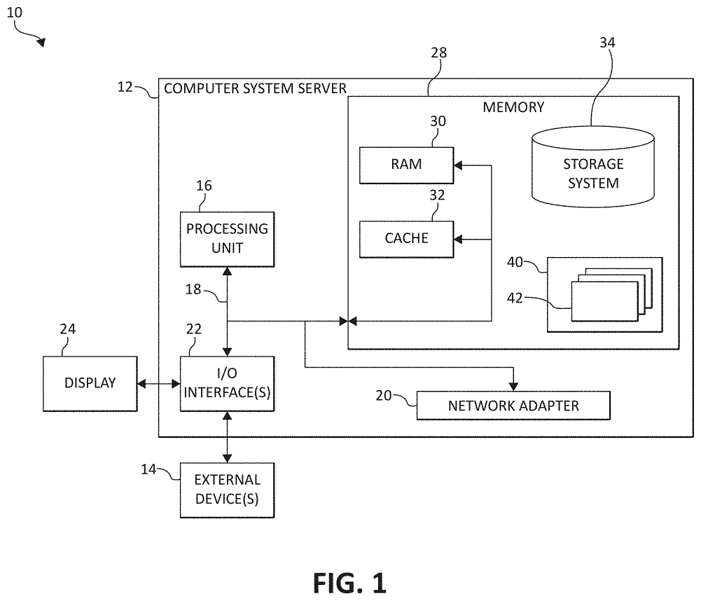

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 12.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

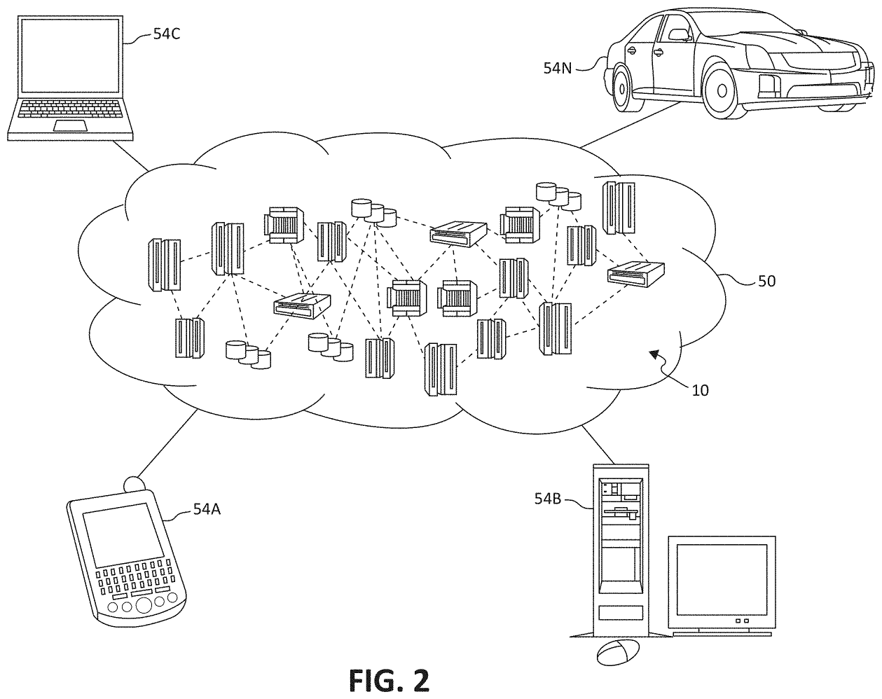

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

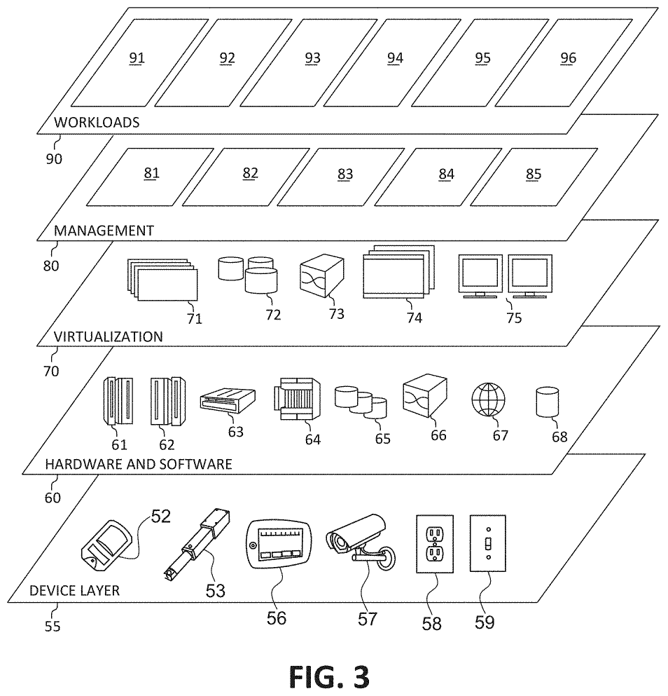

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing federated learning of machine learning model features. In addition, workloads and functions 96 for providing federated learning of machine learning model features may include such operations as data analytics, data analysis, and as will be further described, notification functionality. One of ordinary skill in the art will appreciate that the workloads and functions 96 for federated learning of machine learning model features may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

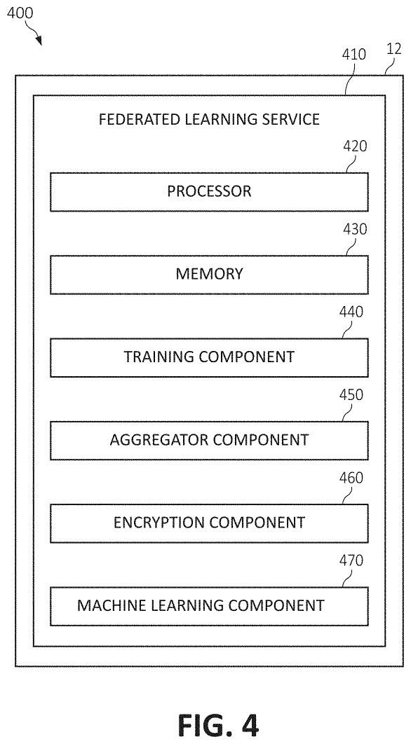

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. Repetitive description of like elements employed in other embodiments described herein is omitted for sake of brevity.

An federated learning service 410 is shown, incorporating processing unit (“processor”) 420 to perform various computational, data processing and other functionality in accordance with various aspects of the present invention. The federated learning service 410 may be provided by the computer system/server 12 of FIG. 1. The processing unit 420 may be in communication with memory 430. The federated learning service 410 may include an training component 440, an aggregator component 450, an encryption component 460, and a machine learning component 470.

As one of ordinary skill in the art will appreciate, the depiction of the various functional units in federated learning service 410 is for purposes of illustration, as the functional units may be located within the federated learning service 410 or elsewhere within and/or between distributed computing components.

In general, by way of example only, the federated learning service 410, using the training component 440 (in association with the machine learning component 470) may learn machine learning model features from one or more data sets extracted from one or more localized machine learning models associated with one or more nodes (e.g., local nodes). The aggregator component 450 may aggregate the machine learning model features using a centralized machine learning model at a source node (e.g., a centralized node that may be defined as an aggregator). The training component 440 (in association with the machine learning component 470) may train one or more of the localized machine learning models using the aggregated machine learning model features provided by the centralized machine learning model (which may be included in and/or associated with the source node/centralized node that may be the aggregator).

The training component 440 (in association with the machine learning component 470) may send one or more gradients and predictions from the source node to the one or more node, and/or receive the one or more gradients and predictions from the one or more nodes to the source node.

The training component 440 (in association with the machine learning component 470) may receive the machine learning model features from the one or more localized machine learning models.

The training component 440 (in association with the machine learning component 470) may 1) train the one or more localized machine learning models to extract the machine learning model feature at the one or more nodes, and/or 2) train the centralized machine learning model using the aggregated machine learning model features at the source node. In one aspect, the encryption component (in association with the training component 440 and the machine learning component 470) may train the centralized machine learning model in an encrypted domain. The received data from the one or more localized machine learning models is encrypted.

In an additional aspect, the aggregator component 450 may perform an entity resolution operation to link data records between the one or more nodes.

In an additional aspect, the machine learning component 470 may be initialized to map input data to a feature vector, initialize one or more parameters of the one or more localized machine learning models or the centralized machine learning model, iteratively update the one or more parameters, perform a forward pass using a machine learning operation to infer the one or more parameters, perform a backward pass using a machine learning operation to determine one or more gradients for the one or more parameters, or perform a combination thereof.

In one aspect, the various machine learning operations of the machine learning component 470, as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

Additionally, the federated learning service 410 (using one or more components therein) may perform one or more various types of calculations or computations. The calculation or computation operations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

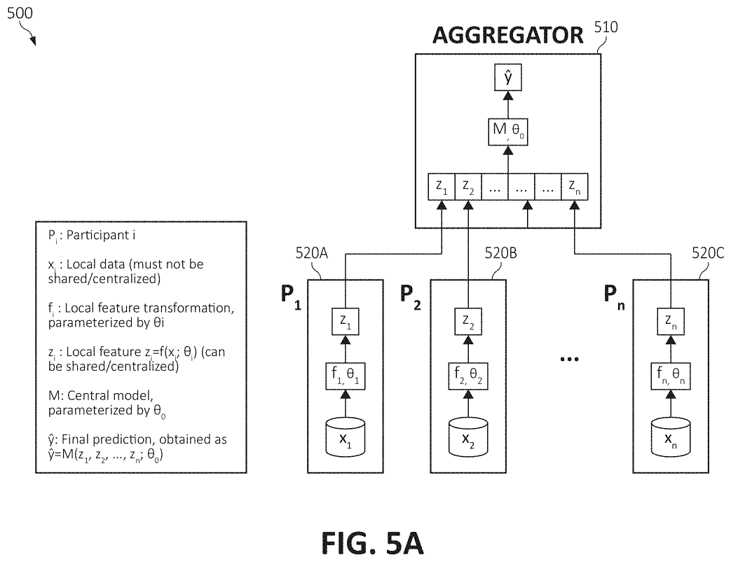

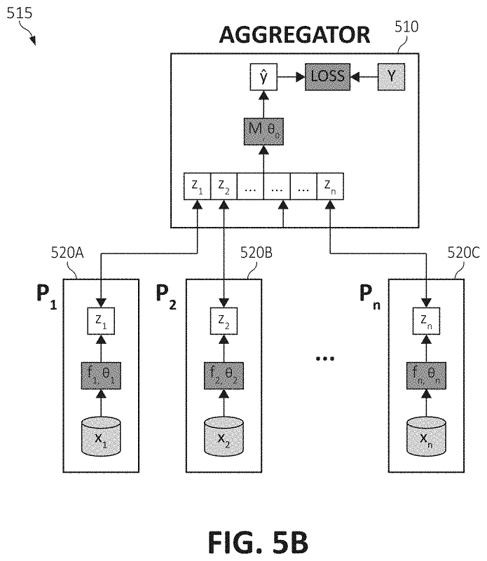

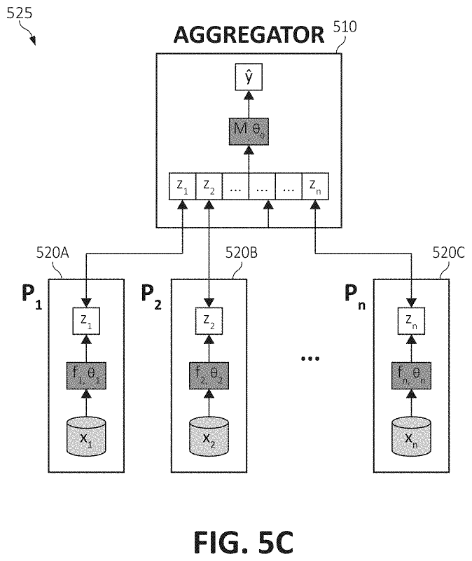

Turning now to FIGS. 5A-5C, a block diagrams 500, 515, and 525 depicts exemplary operations for federated learning of machine learning model features according. In one aspect, one or more of the components, modules, services, applications, and/or functions described in FIGS. 1-4 may be used in FIGS. 5A-5C. Repetitive description of like elements employed in other embodiments described herein is omitted for sake of brevity. Thus, as depicted in FIGS. 5A-5C, the present invention provides for mitigating the problem of optimizing machine learning model features on distributed data by leveraging federated machine learning (“FML”).

As a preliminary matter, as depicted in FIGS. 5A-5C, an aggregator 510 is in communication with one or more local nodes or “participants” such as, for example, participants “Pi” (e.g., P1, P2, and PN) (e.g., participants 520A, 520B, and 520C), where Pi is the ith participant. Within each of the participants (e.g., P1, P2, and PN). As depicted, variable/parameter “xi” is local data (that must not be shared or centralized. The variable/parameter “fi” may be local feature transformation, parameterized by θi. The variable/parameter “zi” may be local features where the variable zi=f(xi; θi) and can be shared/centralized). The variable/parameter “M” may represent a central machine learning model, parameterized by θ₀. The variable/parameter y may be a final prediction that may be obtained as ŷ=M(z1, z2, . . . , zn; θ₀). It should be noted that θ₀ may denote the parameters of model M, and Bi the parameters of feature function fi.

An aggregator 510 (e.g., a source or centralized computing node) is depicted. The aggregator 510 is in communication with one or more local nodes or “participants” such as, for example, participants “Pi” (e.g., P1, P2, and PN) such as, for example, participants 520A, 520B, and 520C, where Pi is the ith participant within each of the participants (e.g., P1, P2, and PN).

In one aspect, the present invention may train a ML model (e.g., y=M(f1(x1), f2(x2), . . . , fn(xn))) where the feature functions f1, f2, . . . , fn may be learned (and not manually created in an ad-hoc fashion and may or may not change during the training of the central machine learning model (“M”), and y is a target variable predicated by the model which can be discrete (e.g., classification task) or continuous (e.g., “regression task”). That is, each function fi (e.g., feature functions f1, f2, . . . , fn) may map raw data input onto a feature vector zi (e.g., where zi=fi(xi)). The central machine learning model (“M”) and the function fi (e.g., the local feature transformation, parameterized by Bi) may be assumed to be optimizable by gradients (or approximations thereof) (e.g., M and fi may all be all (or possibly different) neural networks). The dimensionality of “zi” (e.g., the local features where the variable zi=f(xi; θi) and can be shared/centralized) and/or the architecture of fi may be constrained such that zi doesn't reveal sensitive or proprietary information about “Xi” and thus all “zi” may be centralized.

In one aspect, as depicted in FIG. 5A, a forward pass operation of a machine learning operation (e.g., for deep learning). At the beginning of a training operation, model parameters θ₀, θ₁, . . . , θₙ may be randomly initialized. The model parameters (e.g., θ₀, θ₁, . . . , θₙ) are then iteratively updated in jth iterations, where j is equal to 1, 2, . . . , K (e.g., j=1,2, . . . , K). In particular, in each jth iterations, model parameters θᵢ may be updated via a gradient descent as depicted in the following equation:

θi←θi−α·∇θiL(M(f1(x1;θ1),f1(x1;θ1), . . . ,f1(x1;θ1)),y), (1),

where a is the learning rate (e.g., a hyper-parameter), ∇θi is the gradient with respect to Bi, L is a loss function (e.g., cross-entropy loss for classification task), and y is a ground truth label (as illustrated in FIG. 5B). Thus, a forward pass (depicted in FIG. 5A), which is required for inference, and a backward passes (e.g., FIG. 5B-5C) that are required to compute the gradients for the parameter updates. Also, each of the model parameters Oi may be updated locally (e.g., at each local node/participants P1, P2, and PN) without knowledge about the raw data or exacted feature transformations of any other participant Pi and/or data owner.

In one aspect, in a backwards pass for updating the model function parameters (e.g., θ₀, θ₁, . . . , θₙ) of the central machine learning model (“M”), the aggregator 510 may determine/compute gradients of the machine learning model (“M”) with respect to model function parameters θ₀ evaluated at the local features (e.g., z1, z2, . . . , zn), which is everything the aggregator 510 needs to update the model parameters (e.g., θ₀, θ₁, . . . , θₙ) of the central machine learning model (“M”). It only requires knowledge about the model parameters (e.g., θ₀) of the central machine learning model (“M”), θ₀ and the features (e.g., z1, z2, . . . , zn). It does not require knowledge of the aggregator 510 about the raw data c the functions f1, f2, . . . , fn or the model function parameters (e.g., θ₀, 01, . . . , On).

In an additional aspect, in a backwards pass for updating the model function parameters θᵢ of function fi. The aggregator 510 may determine/compute the gradient of the central machine learning model (“M”) with respect to zi, evaluated at local features z1, z2, . . . , zn) and sends the gradient to local node/participant Pᵢ. The participant Pᵢ multiplies this gradient with the gradient of function fi with respect to model function parameter parameters θᵢ, evaluated at xi. This gives participant Pᵢ the gradient of central machine learning model (“M”) with respect to with respect to model function parameters θᵢ, evaluated at data x1, x2, . . . , xn, which is everything that participant Pᵢ needs to update the model function parameters θᵢ of the functions fi, which require knowledge of the aggregator 510 about data xi, fi or θᵢ nor require knowledge of participant Pᵢ about central machine learning model (“M”), θ₀ or any of the other evaluated local features zj with j≠i.

Additionally, as depicted in FIG. 5B, in a training operation, data may be input as 1) labelled data (e.g., data x1, x2, . . . , xn and in block “y”), 2) components/operations of a machine learning model to be trained (e.g., functions f1, f2, . . . , fn, the central machine learning model (“M”), the model function parameters (e.g., θ₀, θ₁, . . . , θ₀), and/or the loss, where the loss may be a function which measures the discrepancy between model predictions and “ground truth” labels and the objective of model training is to minimize the loss. In one aspect, the present invention may receive these input and generate/produce intermediate results (e.g., ŷ and/or z1, z2, . . . , zn) while training. The present invention may output a trained model.

As depicted in FIG. 5C, in a training step/operation, data may be input as 1) test data (e.g., data x1, x2, . . . , xn and in block “y”), receives the input, and may use a trained machine learning model (components/operations of functions f1, f2, . . . , fn, the central machine learning model (“M”), the model function parameters (e.g., θ₀, θ₁, . . . , θₙ), and/or the loss) to produce output. The present invention may output a predicted value and the intermediate results .g. ŷ and/or z1, z2, . . . , zn)

In an additional aspect, a partial homomorphic encryption can be used so that the aggregator 510 only works on encrypted information received from the participants, and the aggregator 510 does not have access to the unencrypted model, which may be useful in situations where the aggregator 510 process is executed by a third-party provider.

In an additional aspect, training records of different participant Pᵢ need to be linked, e.g., by a foreign key. Another approach is entity resolution, where non-sensitive context information can be used to identify the training records belonging to the same entity. To control the amount of information about xi that is revelated through the features zi one can use statistical techniques (e.g., principal component analysis), or control it through stochastic approaches (e.g., differential privacy) which add random noise either to the raw inputs, the generated features, or any intermediate representations.

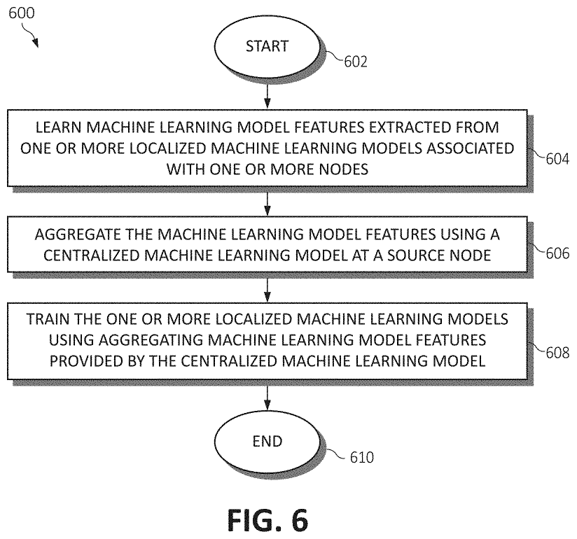

FIG. 6 is a flowchart diagram depicting an exemplary method for providing optimized machine learning model features using federated learning on distributed data in a computing environment. In one aspect, each of the devices, components, modules, operations, and/or functions described in FIGS. 1-5 also may apply or perform one or more operations or actions of FIG. 6. The functionality 600 may be implemented as a method executed as instructions on a machine, where the instructions are included on at least one computer readable medium or one non-transitory machine-readable storage medium. The functionality 600 may start in block 602.

Machine learning model features may be learned from one or more data sets extracted from one or more localized machine learning models associated with one or more nodes, as in block 604. The machine learning model features may be aggregated using a centralized machine learning model at a source node, as in block 606. The one or more localized machine learning models may be trained using aggregated machine learning model features provided by the centralized machine learning model, as in block 608. In one aspect, the functionality 600 may end, as in block 610.

In one aspect, in conjunction with and/or as part of at least one block of FIG. 6, the operations of method 600 may include each of the following. The operations of method 600 may send one or more gradients and predictions from the source node to the one or more nodes, and/or receive the one or more gradients and predictions from the one or more nodes to the source node.

The operations of method 600 may receive the machine learning model features from the one or more localized machine learning models. The operations of method 600 may train the one or more localized machine learning models to extract the machine learning model feature at the one or more nodes, and/or train the centralized machine learning model using the aggregated machine learning model features at the source node. The operations of method 600 may train the centralized machine learning model in an encrypted domain where received data from the one or more localized machine learning models is encrypted.

The operations of method 600 may perform an entity resolution operation to link data records between the one or more nodes. The operations of method 600 may initialize a machine learning mechanism to: map input data to a feature vector; initialize one or more parameters of the one or more localized machine learning models or the centralized machine learning model; iteratively update the one or more parameters; perform a forward pass using a machine learning operation to infer the one or more parameters; and/or perform a backward pass using a machine learning operation to determine one or more gradients for the one or more parameters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing optimized machine learning model features using federated learning on distributed data in a computing environment, comprising:
learning machine learning model features from one or more data sets extracted from one or more localized machine learning models associated with one or more nodes;
aggregating the machine learning model features using a centralized machine learning model at a source node; and
training the one or more localized machine learning models using aggregated machine learning model features provided by the centralized machine learning model.

2. The method of claim 1, where further including:
sending one or more gradients and predictions from the source node to the one or more nodes; or
receiving the one or more gradients and predictions from the one or more nodes to the source node.

3. The method of claim 1, further including receiving the machine learning model features from the one or more localized machine learning models.

4. The method of claim 1, further including:
training the one or more localized machine learning models to extract the machine learning model features at the one or more nodes; and
training the centralized machine learning model using the aggregated machine learning model features at the source node.

5. The method of claim 1, further including training the centralized machine learning model in an encrypted domain, wherein received data from the one or more localized machine learning models is encrypted.

6. The method of claim 1, further including performing an entity resolution operation to link data records between the one or more nodes.

7. The method of claim 1, further including initializing a machine learning mechanism to:
map input data to a feature vector;
initialize one or more parameters of the one or more localized machine learning models or the centralized machine learning model;
iteratively update the one or more parameters;
perform a forward pass using a machine learning operation to infer the one or more parameters; or
perform a backward pass using a machine learning operation to determine one or more gradients for the one or more parameters.

8. A system for providing optimized machine learning model features using federated learning on distributed data in a computing environment, comprising:
one or more computers with executable instructions that when executed cause the system to:
learn machine learning model features from one or more data sets extracted from one or more localized machine learning models associated with one or more nodes;
aggregate the machine learning model features using a centralized machine learning model at a source node; and
train the one or more localized machine learning models using aggregated machine learning model features provided by the centralized machine learning model.

9. The system of claim 8, wherein the executable instructions that when executed cause the system to:
send one or more gradients and predictions from the source node to the one or more nodes; or
receive the one or more gradients and predictions from the one or more nodes to the source node.

10. The system of claim 8, wherein the executable instructions that when executed cause the system to receive the machine learning model features from the one or more localized machine learning models.

11. The system of claim 8, wherein the executable instructions that when executed cause the system to:
train the one or more localized machine learning models to extract the machine learning model features at the one or more nodes; and
train the centralized machine learning model using the aggregated machine learning model features at the source node.

12. The system of claim 8, wherein the executable instructions that when executed cause the system to train the centralized machine learning model in an encrypted domain, wherein received data from the one or more localized machine learning models is encrypted.

13. The system of claim 8, wherein the executable instructions that when executed cause the system to perform an entity resolution operation to link data records between the one or more nodes.

14. The system of claim 8, wherein the executable instructions that when executed cause the system to initialize a machine learning mechanism to:
map input data to a feature vector;
initialize one or more parameters of the one or more localized machine learning models or the centralized machine learning model;
iteratively update the one or more parameters;
perform a forward pass using a machine learning operation to infer the one or more parameters; or
perform a backward pass using a machine learning operation to determine one or more gradients for the one or more parameters.

15. A computer program product for, by a processor, providing optimized machine learning model features using federated learning on distributed data in a computing environment, the computer program product comprising a non-transitory computer-readable storage medium having computer-readable program code portions stored therein, the computer-readable program code portions comprising:
an executable portion that learns machine learning model features from one or more data sets extracted from one or more localized machine learning models associated with one or more nodes;
an executable portion that aggregates the machine learning model features using a centralized machine learning model at a source node; and
an executable portion that trains the one or more localized machine learning models using aggregated machine learning model features provided by the centralized machine learning model.

16. The computer program product of claim 15, further including an executable portion that:
sends one or more gradients and predictions from the source node to the one or more nodes; or
receives the one or more gradients and predictions from the one or more nodes to the source node.

17. The computer program product of claim 15, further including an executable portion that receives the machine learning model features from the one or more localized machine learning models.

18. The computer program product of claim 15, further including an executable portion that:
train the one or more localized machine learning models to extract the machine learning model features at the one or more nodes; and
train the centralized machine learning model using the aggregated machine learning model features at the source node.

19. The computer program product of claim 15, further including an executable portion that:
trains the centralized machine learning model in an encrypted domain, wherein received data from the one or more localized machine learning models is encrypted; or
performs an entity resolution operation to link data records between the one or more nodes.

20. The computer program product of claim 15, further including an executable portion that initializes a machine learning mechanism to:
map input data to a feature vector;
initialize one or more parameters of the one or more localized machine learning models or the centralized machine learning model;
iteratively update the one or more parameters;
perform a forward pass using a machine learning operation to infer the one or more parameters; or
perform a backward pass using a machine learning operation to determine one or more gradients for the one or more parameters.
